(19) United States
(12) Patent Application Publication
(10) Pub. No.: US 2002/0172290 A1
(43) Pub. Date: Nov. 21, 2002

(54) Method and system for transmitting signals between a high speed serial bus and a coaxial cable

(76) Inventors: Jack S. Chorpenning, Cary, NC (US); John M. Dinwiddie, Cary, NC (US)

Correspondence Address: KILPATRICK STOCKTON LLP, 3737 GLENWOOD AVENUE, SUITE 400, RALEIGH, NC, 27612, US

(21) Appl. No.: 09/860,203

(22) Filed: May 18, 2001

(51) Int. Cl. H04B 3/00; H04L 27/18

(52) U.S. Cl. 375/257; 375/281

(57) ABSTRACT

A method and apparatus for transporting signals from a high speed serial bus along a coaxial cable without using the physical layer (PHY). The wires from the high speed serial bus are used as analog inputs to a quadrature modulator. The quadrature modulator has a single radio frequency (RF) signal output that is connected to a coaxial cable for transmission along a distance of up to 100 meters. Furthermore, the RF signal is converted by a direct conversion tuner into signal outputs. The signal outputs are coupled to a second high speed serial bus connection. The high speed serial bus may be IEEE1394, Ethernet, or USB cable.

### FIELD OF THE INVENTION

This invention relates to a method and apparatus for transmitting signals between a high speed serial bus, such as an IEEE1394-1995 cable, an Ethernet cable, or a Universal Serial Bus (USB) to a single conductor coaxial cable, and for transmitting a signal between a high speed serial bus and the coaxial cable.

### BACKGROUND OF THE INVENTION

As used herein, a high speed serial bus is a cable capable of transmitting serial data streams using differential signals through at least one pair of wires, and which requires arbitration logic. Arbitration logic is generally necessary for the use of such high speed serial buses to determine which node is allowed to initiate the next transaction along the bus. By node or device is meant any electronic device, for example, computers, printers, set-top boxes, etc., and the connection associated therewith to other electronic devices through a network. As would be known and understood by one of ordinary skill in the art, a standard method of arbitration logic exists for each type of high speed serial bus. Common high speed serial buses include Ethernet, USB, USB 2.0, and IEEE1394.

USB, Ethernet, and IEEE1394 serial buses are commercially available in several standards. As used herein, the term high speed serial bus is meant to include all standards of high speed serial buses currently available and that may be developed in the future. The most common standard variations of IEEE1394 are IEEE1394-1395 and IEEE1394a. At the time of this writing, the IEEE1394b is being considered as a draft supplement to the IEEE1394a serial bus.

USB is generally available in a USB and a USB 2.0 standard.

The common standard variations of Ethernet are standard Ethernet, which supports data transfer rates of 10 Mbps, 100Base-T Ethernet, which supports data transfer rates of 100 Mbps, and Gigabit Ethernet, which supports data transfer rates of 1000 Mbps.

As used herein, IEEE1394, USB, and Ethernet is meant to include all standards based on the IEEE 1394, USB or Ethernet standards, respectively, whether currently available or developed in the future.

In a more specific aspect, the invention described herein is applicable to a high speed serial bus characterized by the transmission of serial data streams using differential signaling along at least one pair of wires and requiring arbitration logic. By differential signal is meant two signals transported by a pair of wires where a differential output voltage is measured between the two wires. A logical number one is signaled differentially when the voltage on the first wire is higher than the voltage on the second wire, and a logical number zero is signaled differentially when the voltage on the second wire is higher than the voltage on the first wire.

When no signal is driven on the wires, either a high impedance (“Hi Z” or “Z” ) state exists on the wires and no potential difference is detected, as is the case for IEEE1394 , or the undriven wire is forced to a known signal state at the termination point, as is the case for Ethernet and USB.

Most Ethernet and USB serial bus standards employ a single pair of wires to transmit a differential signal. Full Duplex Ethernet and the IEEE1394 serial bus employ two twisted pairs of signal wires to transmit a signal. The IEEE1394 twisted pairs are commonly referred to as twisted pair A (TPA) and twisted pair B (TPB). The individual twisted pair signals are referred to as TPA/TPA* and TPB/TPB*, or TPA and TPB. As would be readily known and understood by one of ordinary skill in the art, the twisted pair wiring in IEEE1394 provides both differential and common mode signaling, which supports the following functions: recognition of device attachment or detachment, resetting devices, arbitration of signal transmissions, packet transmission, automation configuration, and speed signaling.

The electrical characteristics of IEEE1394-1995 and IEEE1394a typically permit a maximum cable length of about 4.5 meters. A USB cable is limited to a length of about 5 meters. Ethernet cables are capable of running approximately 100 meters. The IEEE1394b draft supplement to IEEE1394-1995 and IEEE1394a increases the data rate and transmission distance of previous IEEE 1394 standards. The IEEE1394b supports optical cable lengths of 100 meters for plastic optical fiber, glass optical fiber and Category-5 (CAT-5). CAT-5 is a type of computer network cabling currently used for Ethernet connections that consists of two twisted pairs of copper wires.

The IEEE1394b cable is capable of sending data symbols simultaneously in opposite directions for full duplex operation. By data symbol is meant a binary combination of bits which represents information in compressed form which can later be decompressed. Although the proposed IEEE1394b draft supplement supports cable lengths over a distance of 100 meters, as will be readily known and understood by one of ordinary skill in the art, all devices using the IEEE1394b mode must use a form of non-return to zero binary (NRZ Encoding) signaling, or beta mode, rather than the common mode and differential signaling used in the current IEEE1394 standard. Because NRZ Encoding is used by the IEEE1394b standard cable, devices connected to the IEEE1394b cables must either be configured to run in beta mode or must use a beta connector for translating IEEE1394 standard signals into beta mode. Therefore, while the IEEE1394b standard is backward compatible with existing IEEE1394 devices in theory, it is not trivial to convert existing devices to the IEEE1394b supplement standard in order to increase transmission distances.

Most homes are currently wired with coaxial cables, and thus, it is costly to convert existing coaxial cable wiring to high speed serial bus cables, such as IEEE1394b, Ethernet, plastic optical fiber, glass optical fiber, or CAT-5 wiring, that are capable of transporting differential signals from high speed serial buses over distances greater than 5 meters. However, many devices are commercially available that require high speed serial bus connections. Therefore, it is desirable to transport signals from high speed serial buses through coaxial cable such that existing cable wiring can be used.

One method for converting signals from an Ethernet cable to a coaxial cable is called Data-Over-Cable Service Interface Specifications (“DOCSIS”). DOCSIS specifies the protocol for exchanging bi-directional Ethernet signals over a coaxial cable.

DOCSIS operates within the Open System Interconnection (“OSI”) Model. The OSI Model defines a networking framework for implementing communication protocols in seven layers: 1) the Application Layer, 2) the Presentation Layer, 3) the Session Layer, 4) the Transport Layer, 5) the Network Layer, 6) the Data Link Layer and 7) the Physical Layer. Each layer has a separate function. For example, the Application Layer manages program to program communication, the Network Layer routes data from one node to another, etc. Data is transferred from one network media to another by passing control of the data from the Application Layer through all seven layers to the Physical Layer (“PHY”). The PHY layer is a physical PHY chip located on the network. The data is then passed over a channel or communications path such as a wire or cable to a second device where control of the data is passed from the PHY through all seven layers to the Application Layer.

DOCSIS operates between the Media Access Control (“MAC”) Layer and the Physical Layer. The MAC Layer is a sublayer of the Data Link Layer, which is responsible for physically passing data from one node to another. The MAC Layer moves data packets to and from one Network Interface Card (“NIC”) to another across a shared channel. The protocols used in the MAC Layer ensure that signals sent from different network media across the same channel will not collide. The Physical Layer manages putting data onto and taking data off of the network media.

The method used by DOCSIS takes a digital signal from in between the Physical Layer and the MAC Layer. The digital signal is passed through a digital to analog converter. The resulting analog signal is then used as an input to a quadrature modulator. By quadrature modulator is meant a device conventionally used to modulate a high-frequency carrier with lower frequency data. A quadrature modulator uses quadrature amplitude modulation to compress a signal onto a single Radio Frequency (RF) output, which may then be transported along a coaxial cable. Quadrature amplitude modulation is a method for encoding digital data in an analog (RF) signal in which each combination of phase and amplitude represents a bit pattern or data symbol, for example, one of sixteen four bit patterns, one of sixty-four eight bit patterns, etc. In order to transmit high speed data in using DOCSIS, the inputs to the quadrature modulator typically include a mixer for converting the signals to an Intermediate Frequency (IF). A receiver demodulator is used to receive the signal from the coaxial cable in DOCSIS. For high speed data transmission, the receiver demodulator also includes a mixer for stripping the IF signal. A typical receiver demodulator with analog to digital conversion is shown in FIG. 1 (Prior Art) of U.S. Pat. No. 6,031,878 to Tomasz et al., entitled, “Direct-Conversion Tuner Integrated Circuit for Direct Broadcast Satellite Television,” (hereinafter “the Tomasz patent”).

In addition, the interception of the signal from between the PHY and the MAC layer is an identifiable part of the network. In other words, the PHY chip as defined by the system architecture has a physical address (a source or destination address). When information is received by a PHY chip, it can be redirected using standard protocols to other ports or to a higher level chip level such as the MAC layer.

One disadvantage of the DOCSIS method of transporting Ethernet signals on a coaxial cable is the high overhead due to the interception of the signal between the Physical Layer and the MAC Layer, which requires the use of a digital to analog converter and other data processing mechanisms and protocols. Another disadvantage is that the method is only used with respect to Ethernet signals and does not transport USB or IEEE1394 signals or other high speed serial bus signals.

### SUMMARY OF THE INVENTION

In accordance with the method and apparatus described herein, it was discovered that signals directly from the wires of a high speed serial bus can be converted into an RF signal and transported over a distance of approximately 100or more meters on a coaxial cable. The RF signals are received and converted to baseband in-phase/quadrature phase signals that are further transmitted along a high speed serial bus. Thus, each end of the coaxial cable is configured for receiving and transmitting such signals between a coaxial cable and a high speed serial bus. The method and apparatus described herein eliminates the need for rewiring by supporting all high speed serial bus standards, including all variations of IEEE 1394, USB, and Ethernet, over a coaxial cable where signals may be transmitted over a distance of approximately 100 meters or more. Unlike, DOCSIS, the method and apparatus described herein is not identifiable to the network environment because the signal is intercepted directly along the high speed serial bus cable wire without the use of the PHY or MAC layers as utilized in DOCSIS. In addition, an analog to digital converter is not used. The method and apparatus described herein forms a “virtual wire” that is not detected by nodes in the network.

Signals from a high speed serial bus are converted into an RF signal using a quadrature modulator. The RF signal is coupled to a coaxial cable for transmission. When the RF signals are received, a direct conversion tuner connected to the coaxial cable converts the RF signals to baseband in-phase/quadrature phase signals, which are coupled to a high speed serial bus. Thus, a high speed serial bus signal may be converted to an RF signal, transmitted along coaxial cables for a distance of up to 100 meters, and then converted to a receiving high speed serial bus. All variations of high speed serial buses such as IEEE1394, USB, and Ethernet transmissions are supported by the method and apparatus described herein.

As would be readily known and understood by one of ordinary skill in the art, a quadrature modulator has four inputs: ISIG, IREF, QSIG and QREF and a single RF output.

By direct conversion tuner is meant a converter conventionally used for the conversion of direct broadcast satellite signals such as those used for digital television, for example, the direct conversion tuner disclosed in the Tomasz patent. A direct conversion tuner accepts a single RF signal input and generates the in-phase and quadrature phase components of the RF signal. Direct conversion tuners typically have four outputs, ISIG, IREF, QSIG and QREF.

In one aspect of the method, the wires from the high speed serial bus are direct inputs to the In-phase Signal (ISIG), In-phase Reference (IREF), the Quadrature-phase Signal (QSIG) and Quadrature-phase Reference (QREF) inputs of a quadrature modulator. The resulting radio frequency (RF) signal is coupled to a coaxial cable. Preferably, the signals from the high speed serial bus are level converted to voltage levels in the linear range of the quadrature modulator. More preferably, the method includes arbitrating which request from at least one device or node has priority for transmitting digital signals to the coaxial cable.

Preferably, the method includes receiving an RF signal from the coaxial cable and converting the RF signal into multiple signals for transportation along a high speed serial bus. The tuned RF signal is converted to a baseband in-phase/quadrature phase signal using a direct conversion tuner coupled to the coaxial cable. The resulting in-phase/quadrature phase signals are coupled to wires of a high speed serial bus. The method includes arbitrating which request from at least one device or node has priority for transmitting digital signals. Preferably, the resulting in-phase/quadrature phase signals are level converted by increasing the voltage level prior to coupling the in-phase/quadrature phase signals to the high speed serial bus.

In another aspect, the method relates to transporting signals between an IEEE1394 cable and a coaxial cable. An IEEE1394 cable has two pairs of twisted wires. The first pair of wires is used as an input to the ISIG and IREF inputs of a quadrature modulator and the second pair of wires is used as an input to the QSIG and QREF inputs of a quadrature modulator. The resulting RF output may be transported along a coaxial cable, and converted by a direct conversion tuner. The ISIG, IREF, QSIG and QREF outputs of the direct conversion tuner are coupled with the four wires of a second IEEE1394 wire.

In yet another aspect, an apparatus transports high speed serial bus signals over a coaxial cable. The apparatus includes a coaxial cable for transmitting an RF signal and a direct quadrature modulator with analog inputs for In-phase (ISIG), In-phase Reference (IREF), Quadrature-phase Signal (QSIG) and Quadrature-phase Reference (QREF). A high speed serial bus is coupled to the quadrature modulator such that the at least one of the high speed serial bus wires is used as an input to the ISIG, IREF, QSIG and QREF inputs. A voltage controlled oscillator (VCO) is set at a frequency that reflects the rate of data transmission and connected to the quadrature modulator. By voltage controlled oscillator is meant a low-noise local oscillator. Voltage controlled oscillators are commercially available from companies including Maxim Integrated Products, Inc. which manufactures VCO's under the name MAX2620.

The apparatus includes a direct conversion tuner with an RF signal input coupled to the coaxial cable for converting the RF signal into baseband ISIG, IREF, QSIG, and QREF outputs. The ISIG/IREF and QSIG/QREF outputs are coupled to the wires of a high speed serial bus. An arbitration logic array is connected to the quadrature modulator and the direct conversion tuner for detecting and arbitrating the signals from the ISIG/IREF and QSIG/QREF inputs and the ISIG/IREF and QSIG/QREF outputs. More preferably, the apparatus includes a second VCO set at a different frequency from the first VCO and connected to the direct conversion tuner. Most preferably, the apparatus includes a microprocessor connected to the arbitration logic array and both VCO's for setting voltage levels and a driver/receiver module connected to the microprocessor and coaxial cable for driving and receiving a signal.

Preferably, the apparatus includes a second direct quadrature modulator with analog ISIG/IREF and QSIG/QREF inputs with an RF output coupled to the other end of the coaxial cable, and a second direct conversion tuner with an RF signal input coupled to the second end of the coaxial cable for converting an RF signal input into baseband ISIG/IREF and QSIG/QREF outputs. A third VCO is connected to the quadrature modulator and is set at the same frequency as the second VCO. A fourth VCO is connected to the direct conversion tuner and is set at the same frequency as the first VCO. A second arbitration logic array is connected to the second quadrature modulator and the second direct conversion tuner for detecting and arbitrating signals from the second ISIG/IREF and QSIG/QREF outputs. A second high speed serial bus having at least one pair of wires is coupled to the second arbitration logic array. The wires from the second high speed serial bus are connected to the ISIG, IREF, QSIG and QREF inputs.

More preferably, the apparatus includes a microprocessor connected to the first arbitration logic array, and the first and the second VCO's for setting voltage levels. A second microprocessor is connected to the second arbitration logic array, and the third and fourth VCO's for setting voltage levels. A driver/receiver module is connected to the first microprocessor and the one end of the coaxial cable for driving and receiving a signal. A second driver/receiver module is connected to the second microprocessor and the second end of the coaxial cable for driving and receiving a signal.

In another aspect of the invention, the apparatus has a coaxial cable for transmitting an RF signal and a direct conversion tuner with an RF signal input coupled to the coaxial cable for converting the RF signal input to baseband ISIG/IREF and QSIG/QREF outputs. A high speed serial bus is coupled to the direct conversion tuner for receiving the ISIG/IREF and QSIG/QREF outputs. The wires of the high speed serial bus are connected to the ISIG/IREF and QSIG/QREF outputs.

In yet another aspect of the invention, the apparatus transmits signals between a coaxial cable and an IEEE1394 cable. The apparatus includes a coaxial cable for transmitting an RF signal and a direct quadrature modulator with analog inputs for In-phase (ISIG), In-phase Reference (IREF), Quadrature-phase Signal (QSIG) and Quadrature-phase Reference (QREF). A IEEE1394 cable is coupled to the quadrature modulator such that the TPA/TPA* wires are used as inputs to the ISIG and IREF inputs, and TPB/TPB* wires are used as inputs to the QSIG and QREF inputs. A voltage controlled oscillator (VCO) is set at a frequency that reflects the rate of data transmission and connected to the quadrature modulation.

The apparatus includes a direct conversion tuner with an RF signal input coupled to the coaxial cable for converting the RF signal into baseband ISIG, IREF, QSIG, and QREF outputs. The ISIG/IREF and QSIG/QREF outputs are coupled to the wires of the IEEE1394 cable. An arbitration logic array is connected to the quadrature modulator and the direct conversion tuner for detecting and arbitrating the signals from the ISIG/IREF and QSIG/QREF inputs and the ISIG/IREF and QSIG/QREF outputs. More preferably, the apparatus includes a second VCO set at a different frequency from the first VCO and connected to the direct conversion tuner. Most preferably, the apparatus includes a microprocessor connected to the arbitration logic array and both VCO's for setting voltage levels and a driver/receiver module connected to the microprocessor and coaxial cable for driving and receiving a signal.

### BRIEF DESCRIPTION OF THE DRAWINGS

FIG. 1 is a schematic drawing showing a quadrature modulator.

FIG. 2 is a graph showing the conventional method of quadrature modulation.

FIG. 3 is a graph of a signal from an IEEE1394 cable.

FIG. 4 is a schematic drawing showing a coaxial cable that is connected to a IEEE1394 node on both ends using the apparatus and method.

FIG. 5 is a schematic drawing showing in greater detail one end of the same coaxial cable connected to a IEEE1394 node.

### DETAILED DISCUSSION OF THE INVENTION

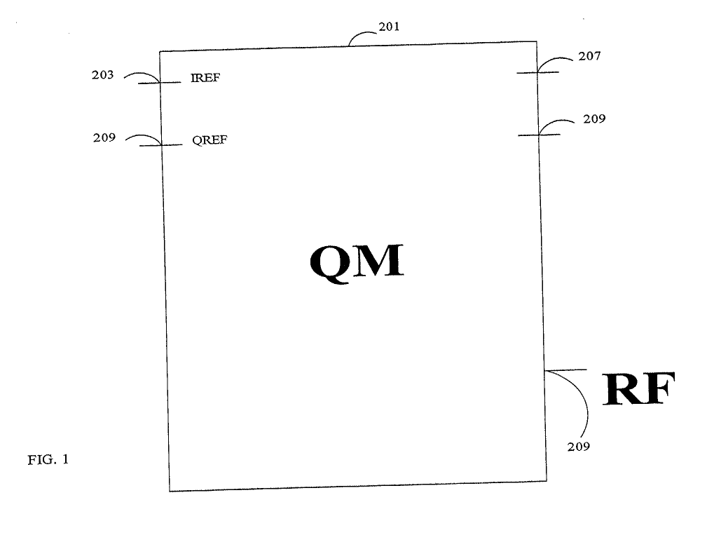

FIG. 1 shows a simplified schematic of drawing of a conventional quadrature modulator 201 showing only the inphase/quadrature phase signal inputs and Radio Frequency (RF) output. As will be readily known and understood by one of ordinary skill in the art and as described in the Background of the Invention, a quadrature modulator 201 is conventionally used to modulate a high-frequency carrier with lower frequency data. A quadrature modulator compresses data onto a single RF output, which may then be transported along a coaxial cable. As will be better understood by the discussion that follows, the data is compressed by using a method for encoding digital data in an analog signal in which each combination of phase and amplitude represents a bit pattern or data symbol. For example, the bit pattern or data symbol may be one of sixteen four bit patterns, one of sixty-four eight bit patterns, etc.

A conventional quadrature modulator has ports for In-phase Signal (ISIG) 207, In-phase Reference (IREF) 203, Quadrature-phase Signal (QSIG) 209, and Quadrature-phase Reference (QREF) 205 inputs. In a conventional configuration, digital signals are converted to analog signals using a standard digital-to-analog converter and then used as the inputs to ISIG 207 and QSIG 209. Quadrature modulators are commercially available from several companies, including, RF Micro Devices, Inc., which sells a 2.5GHz Direct Quadrature Modulator under the name RF2422.

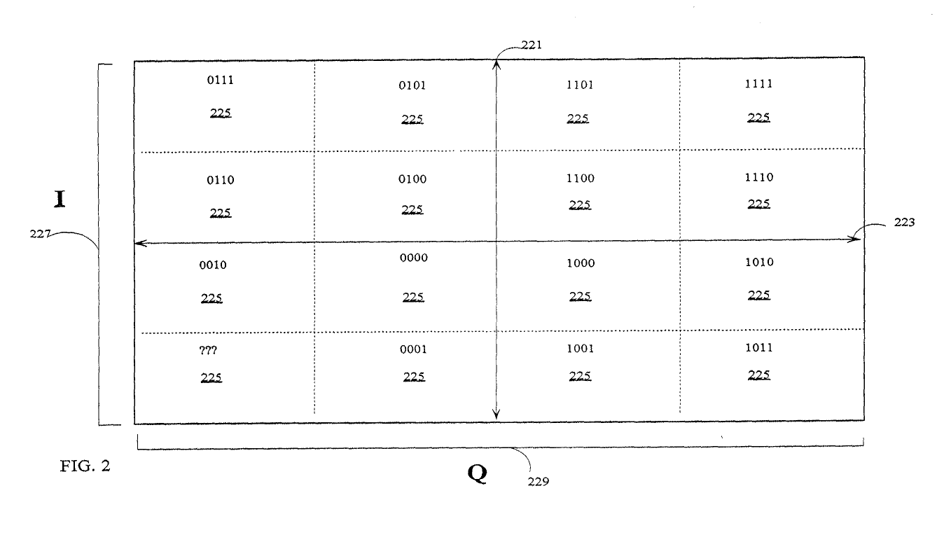

FIG. 2 is a graph illustrating the quadrature amplitude modulation method that is used by the quadrature modulator to generate an RF signal. The signals from the ISIG 207 and QSIG 209 inputs each have a voltage level at any given time that may be graphed as shown in FIG. 2. The ISIG voltage 223 is shown along the x-axis and the QSIG voltage 221 is shown along the y-axis. The IREF 203 and QREF 205 inputs are used to set the voltage levels which determine the voltage ranges 227 and 229.

Each value for a combined QSIG and ISIG voltage 221 and 223 will fall into one of the sixteen quadrant subdivisions 225. Each quadrant subdivision is associated with a four digit bit. The four digit binary bit determines the resulting RF signal produced by the RF output 211 in FIG. 1. As will be understood by one of ordinary skill in the art, the resulting RF signal is an analog representation of the four digit binary bit. The amplitude and phase components of the RF signal each represent a digit of the four digit binary bit. For example, an amplitude of one volt might correspond to assigning a 0 to one digit of the bit, while an amplitude of two volts might correspond to assigning a 1 to the same digit. In the same manner, a given phase shift will correspond to other bit values. It is wellknown in the art that the resulting RF representation of the digital bits may be translated back to the original digital signal using a direct conversion tuner that has an ISIG and IREF output. A standard analog-to-digital converter converts the ISIG and IREF outputs from the direct conversion tuner back to the original digital signal that was the input to the quadrature modulator.

The above described technique for compressing digital signals into an RF signal is well-known in the art. The example above pertains to four digit binary bits. However, the same technique may be used with two digit binary bits in four quadrants of the graph, eight digit binary bits in sixty-four quadrant subdivisions of the graph, etc.

As discussed in the Background of the Invention, this technique is used to transmit Ethernet signals over a coax cable in DOCSIS. However, the DOCSIS method of transporting Ethernet signals on a coaxial cable has high overhead due to the interception of a digital signal between the Physical Layer and the MAC Layer in the ISO Model. In addition, the quadrature modulation in DOCSIS requires a digital signal and the use of a digital to analog converter. DOCSIS is an identifiable part of the network and has an Internet Protocol (“IP”) address. The method is also only used with respect to Ethernet signals and has not been used to transport USB or IEEE1394 signals or other high speed serial bus signals.

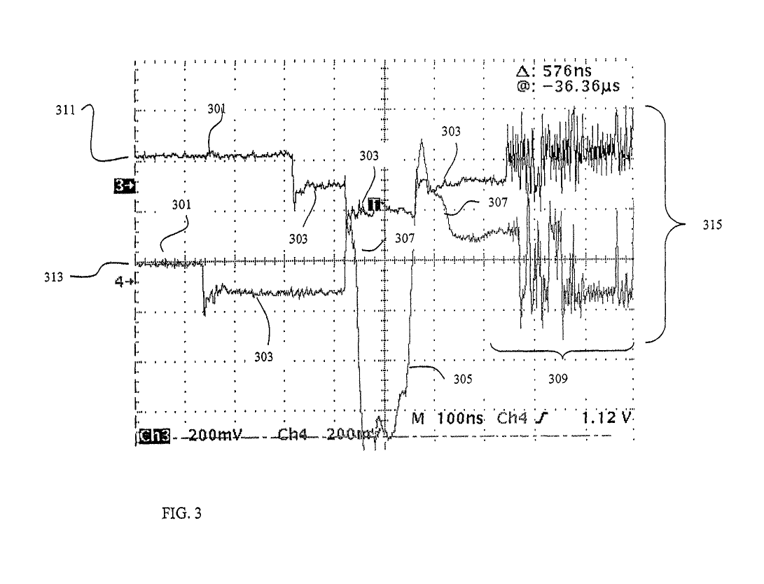

As will be better understood by the discussion that follows, the apparatus and method described herein intercepts an analog signal directly from anywhere along the high speed serial bus wire. Because the signal does not need to be intercepted from within the ISO Model, the associated overhead is low when compared to DOCSIS. The method and apparatus described herein is not identifiable to the network environment because the signal is intercepted directly along the high speed serial bus cable wire without the use of the PHY or MAC layers as utilized in DOCSIS. A “virtual wire” that is not detected by nodes in the network is formed. No digital to analog converter is used. Unlike DOCSIS, the method may be used with Ethernet as well as USB and IEEE1394 signals. Thus, the signals used by the method may be complex analog signals intercepted directly along a high speed serial bus wire rather than a digital signal from within the ISO Model. Such signals may include both common mode and differential signaling, or only differential signaling, as described in more detail below. An example of a signal directly from an IEEE1394 wire is shown in FIG. 3.

FIG. 3 shows two signals 311 and 313 from a twisted pair of wires in the IEEE1394 cable. Each signal has a z state 301 that is at a specified voltage. If the voltage drops below the voltage of the z state 301, as shown in section 303, the signal represents a “0.” If the voltage rises above the voltage of the z state 301, as shown in section 307, the signal represents a “1.” The voltages representing “0” or “1” is within a range 315. If the signal drops outside the range 315 as is shown in section 305, the signal conveys common mode signaling. Common mode signaling as shown in section 305 still represents a differential “0” or “1.” However, common mode signaling also conveys additional information, for example, device attachment/detachment, speed signaling, and suspending and resuming signaling. Section 309 represents high speed data transfer. As shown in section 309, the signal oscillates more rapidly between representation of “0” and “1” than at other points shown in FIG. 3.

Signals from USB and Ethernet contain differential signaling appear similar to the signal shown in FIG. 3. However, USB and Ethernet signals do not include common mode signaling shown in section 305.

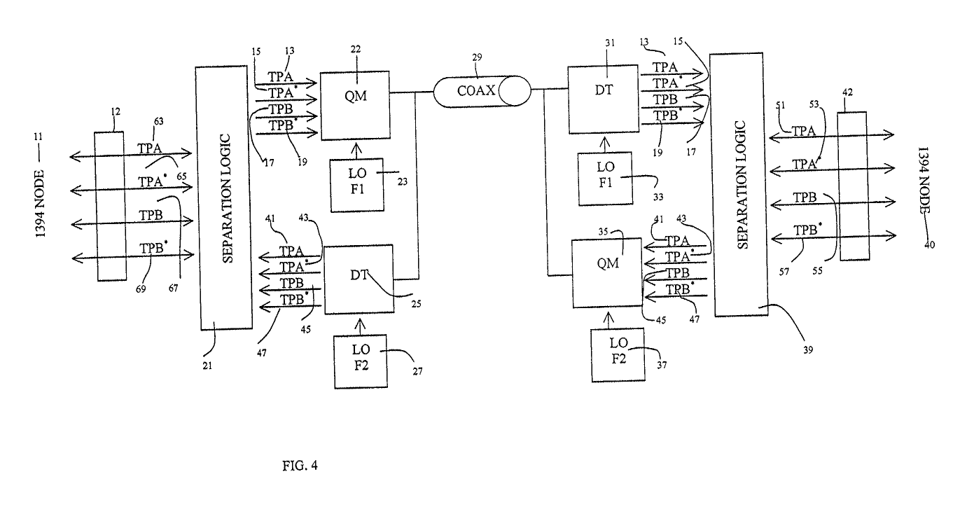

In accordance with the apparatus and method described herein, FIG. 4 shows a schematic drawing of a coaxial cable that is connected on both ends to a high speed serial bus, such as a IEEE1394 node. The IEEE1394 node 11 has two pairs of twisted wires: TPA/TPA*(Twisted Pair A) wires 63 and 65 and TPA/TPB*(Twisted Pair B) wires 67 and 69. An arbitration logic array 21 detects and arbitrates signals from the direct conversion tuner 25 (TPA/TPA* wires 13 and 15 and TPA/TPB*wires 17 and 19), to the quadrature modulator 22 (TPA/TPA*wires 41 and 43 and TPA/TPB*wires 45 and 47), and to and from the TPA/TPA*wires 63 and 65 and TPA/TPB*wires 67 and 69.

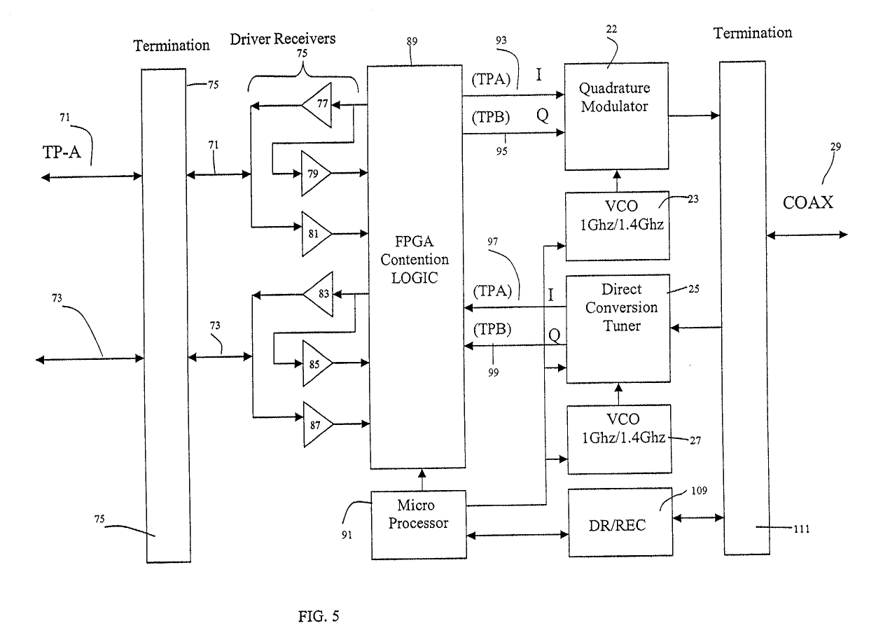

As will be readily known and understood by one of ordinary skill in the art, an arbitration logic array is necessary in any high speed serial bus connection to determine which request from at least one device or node has priority for transmitting digital signals to the TPA/TPA*wires 63 and 65 and TPA/TPB* wires 67 and 69. The arbitration logic array may be a conventional array, for example, a standard arbitration logic array as described in greater detail in FIREWIRE® SYSTEM ARCHITECTURE, 2d edition, 95-163 by Don Anderson, the text of which is herein incorporated by reference. Other conventional arrays are well-known portions of the USB and Ethernet standards. A conventional configuration of an arbitration logic array is described in more detail in the discussion accompanying FIG. 5.

The TPA/TPA*wires 13 and 15 and TPA/TPB*wires 17 and 19 are used as direct analog inputs to the quadrature modulator 22. Preferably, the voltage level of the TPA/TPA*wires 63 and 65 and TPB/TPB*wires 67 and 69 are level converted and transmitted to TPA/TPA*wires 13 and 15 and TPA/TPB*wires 17 and 19. More preferably, the voltage levels of TPAJTPA*wires 63 and 65 and TPA/TPB*wires 67 and 69 are level converted such that TPA/TPA*wires 13 and and TPA/TPB*wires 17 and 19 are in the linear range of the quadrature modulator. A quadrature modulator operating in the linear range dose not use the conventional method of quadrature modulation described in FIG. 2. In the linear range, there are no quadrant subdivisions 225 as shown in FIG. 2, and I 223 and Q 221 voltages are mapped continuously. However, the quadrature modulator chip itself may be a conventional quadrature modulator as described in FIG. 1.

Turning back to FIG. 4, unlike the conventional ISIG/IREF and QSIG/QREF signal inputs, which are derived from a digital to analog converter, the signals from the TPA/TPA*wires 13 and 15 and TPA/TPB*wires 17 and 19 are analog signals intercepted directly from the high speed serial bus wire. There is no analog to digital conversion or IF mixing. The PHY chip is not used. Unlike ISIG/IREF and QSIG/QREF signal inputs in a conventional configuration, TPA/TPA*and TPB/TPB*signals carried along an IEEE1394 cable, or alternatively, Ethernet, and USB cable, contain differential mode signaling. An example of a signal containing both common mode and differential signaling from an IEEE1394 cable is shown in FIG. 3, described above.

Alternatively, differential signaling is used by a IEEE1394 cable for the following functions: resetting devices, arbitrating signals, configuration of devices, and packet transmission. The differential mode signaling environment transmits digital signals at speeds of 100, 200, or 400 MHz. Differential signaling on an IEEE1394 cable has three signal states: differential 1 (when the voltage of the first wire is higher than the second), differential 0 (when the voltage of the second wire is higher than the first), and Hi Z. The Z state represents an undriven state. Differential signaling on an Ethernet or USB cable includes two states: differential 0 and differential 1. When an Ethernet or USB cable is undriven, the wire is forced into either the differential 0 or differential 1 state at the termination point.

As will be readily known by one of ordinary skill in the art, a quadrature modulator is typically driven by a local oscillator 23. The local oscillator 23 drives the quadrature modulator at a specific frequency, which reflects the rate that data is transferred by the system.

The quadrature modulator 22 has an RF output that is coupled to the coaxial cable 29 for signal transmission. The signal from the coaxial cable is then received by a direct conversion tuner 31.

As will be readily understood by one of ordinary skill in the art, direct conversion tuners are commercially available from several companies, for example, Maxim Integrated Products, Inc. Preferably, the direct conversion tuners 31 and 25 are of the type described in the Tomasz patent. However, the DirectConversion Tuner Integrated Circuit disclosed in Tomasz et al. as well as similar direct conversion tuners are designed for direct conversion of direct broadcast satellite signals such as those used for digital television to baseband in-phase and quadrature-phase signals. In accordance with the system and method herein, an RF signal from a coaxial cable can be used as an input for the direct conversion tuner 31 to achieve the result of generating differential signals suitable for transmission on a high speed serial bus.

The direct conversion tuner 31 is driven by a local oscillator 33. The local oscillator 33 drives the direct conversion tuner at a specific frequency, which reflects the rate that data is transferred by the system. Preferably, the local oscillator 33 is set to the same frequency as local oscillator 23, because the rate of data transfer from the quadrature modulator 22 to the direct conversion tuner 31 through the coaxial cable 29 is the same.

The direct conversion tuner, such as the direct conversion tuner that is described in the Tomasz patent, has four outputs. The direct conversion tuner ordinarily uses a direct broadcast satellite signal such as those used for digital television as an input. When a direct broadcast satellite signal is used as an input, the four outputs from a direct conversion tuner are baseband in-phase and quadrature-phase signals. In the system described herein, an RF signal from the quadrature modulator 22 is used as an input to the direct conversion tuner 31, the four outputs are the same as the IEEE1394 signals: TPA 13, TPA*15, TPB 17, and TPB*19.

Preferably, the voltage level of the TPA 13, TPA*15, TPB 17, and TPB* 19 are level converted and transmitted to TPA/TPA*wires 51 and 53 and TPA/TPB*wires 55 and 57. More preferably, the voltage levels of TPA 13, TPA*15, TPB 17, and TPB*19 are increased such that TPA/TPA*wires 51 and 53 and TPA/TPB*wires 55 and 57 are in a range appropriate for transmission along a IEEE1394 node.

The IEEE1394 signals, TPA 13, TPA* 15, TPB 17, and TPB* 19, are transmitted into an arbitration logic array 39. The arbitration logic array 39 is connected 42 to TPA/TPA* wires 51 and 53 and TPA/TPB* wires 55 and 57 from a second IEEE1394 node 40 for this purpose. As will be readily known and understood by one of ordinary skill in the art, an arbitration logic array is necessary in any IEEE1394 connection to determine which request from at least one device or node has priority for transmitting signals the TPA/TPA* wires 51 and 53 and TPA/TPB* wires 55 and 57. The arbitration logic array 39 may be a conventional array, for example, a standard arbitration logic array as described in 2 FIREWIRE® SYSTEM ARCHITECTURE, 2d edition, 95-163 by Don Anderson. Other standard arbitration logic arrays are specified by USB and Ethernet standards.

As will be readily understood by one of ordinary skill in the art, the wires of an IEE1394 node 40 and 11, TPA/TPA* wires 51, 53, 63, and 65 and TPA/TPB* wires 55, 57, 67, and 69, are capable of receiving and sending signals simultaneously. The system distinguishes ingoing and outgoing signals from the IEEE1394 nodes 40 and 11 by the frequency at which the signals are sent. Therefore, signals outgoing from IEEE1394 node 11 are carried at a given data rate, or frequency. Local oscillators 23 and 33 drive quadrature modulator 22 and direct conversion tuner 33 at this same frequency. The arbitration logic arrays 21 and 39, which may be a standard arbitration logic array, further function to separate incoming and outgoing signals based on the frequency at which they are sent.

Signals from IEEE1394 node 40 are transported through coaxial cable 29 to IEEE1394 node 11 using the same method, described above, that signals from IEEE1394 node 11 are transported through coaxial cable 29 to IEEE1394 node 40. Thus, signals from IEEE1394 node 40 from TPA/TPA* wires 51 and 53 and TPA/TPB* wires 55 and 57, are connected to the arbitration logic array 39. The outgoing signals, TPA/TPA* 41 and 43, and TPB/TPB* 45 and 47 are used as analog inputs to the quadrature modulator 35. As with quadrature modulator 22 and as will be readily known and understood by one of ordinary skill in the art, quadrature modulator 35 has four inputs, ISIG/IREF and QSIG/QREF.

The quadrature modulator is driven by local oscillator 37 at a frequency which reflects the rate of data transfer from the IEEE1394 node 40. The quadrature modulator has a single RF output, which is connected to the coaxial cable 29. The signal is transmitted along the coaxial cable 29, and received by the direct conversion tuner 25. As with direct conversion tuner 35, direct conversion tuner 25 may be a conventional direct conversion tuner, such as the direct conversion tuner described in the Tomasz patent. The direct conversion tuner 25 is driven by a local oscillator 27 at the same frequency as quadrature modulator 35.

As in the case with direct conversion tuner 31, direct conversion tuner 25 has four outputs. A conventional direct conversion tuner uses a direct broadcast satellite signal such as those used for digital television as an input rather than an RF signal. When a direct broadcast satellite signal is used as an input, the four outputs from a direct conversion tuner are baseband in-phase and quadrature-phase signals. However, when an RF signal from the quadrature modulator 22 is used as an input to the direct conversion tuner 31, the four outputs are the same as the IEEE1394 signals: TPA 41, TPA* 43, TPB 45, and TPB* 47. The four outputs 41, 43, 45, and 47 are connected to arbitration logic array 21. As described above, an arbitration logic array is necessary in any IEEE1394 connection to determine which request from at least one device or node has priority for transmitting digital signals to the TPA/TPA*) wires 63 and 65 and TPA/TPB* wires 67 and 69.

FIG. 5 shows in greater detail one end of the coaxial cable 29 connected to a IEEE1394 node. Both twisted pairs of wires from the IEEE1394 node, TPA 71 and TPB 73 are connected to the system by a termination point 75. The signals 71 and 73 are connected to an arbitration logic array 89 through a series of drivers and receivers 77, 79, 81, 83, 85, and 87. The drivers and receivers 77, 79, 81, 83, 85, and 87 are configured to detect signals received from the arbitration logic array 89 and the TPA 71 and TPB 73 wires. As will be readily known and understood by one of ordinary skill in the art, the drivers and receivers 77, 79, 81, 83, 85, and 87 are a necessary component of an arbitration gate array, and the configuration shown in FIG. 5 is one such conventional configuration. The arbitration array 89 may be a field programmable gate array (FPGA). As described above, the arbitration array 89 may be standard arbitration array.

Receivers 79 and 85 detect signals from the arbitration array 89. These signals are received from the direct conversion tuner 25 and are transported to IEEE1394 wires TPA 71 and TPB 73. Receivers 79 and 85 detect signals received from the ISIG/IREF outputs 97 and QSIG/QREF outputs 99 from the direct conversion tuner 25. Driver 77 drives the ISIG/IREF signal 97 to the TPA wires 71, and driver 83 drives the QSIG/QREF signal 99 to the TPB wires 73. Receiver 81 detects a signal that derives from both the TPA wires 71 and driver 77, and receiver 87 detects a signal derived from both TPB wires 73 and driver 83.

The information from all four receivers 79, 81, 85, and 87 are communicated to the FPGA Contention Logic 89. The FPGA Contention Logic 89 compares the signals from the receivers 79, 81, 85, and 87 to determine which wires TPA 71, TPB 73 and coax cable 29 are driving a signal.

By comparing the information from receivers 79, 81, 85, and 87, the arbitration logic array determines whether there are multiple devices that are competing for simultaneous transmission. The arbitration logic array 89 determines which device has control of the TPA 71 and TPB 73 wires and the coaxial cable 29. By control is meant that the device is allowed to transmit data. The decoding rules for the arbitration information from receivers 79, 81, 85, and 87 and drivers 77 and 83 are defined by the IEEE1394 system architecture. See FIREWIRE® SYSTEM ARCHITECTURE, 2d Edition, 5-163 by Don Anderson. Analogous arbitration logic and decoding rules are defined by the system architectures for USB and Ethernet wires.

As described above in FIG. 4, the incoming signals from the TPA 71 wire and TPB 73 wire are used as ISIG/IREF 93 inputs and QSIG/QREF 95 inputs to the quadrature modulator 22. A local oscillator 23 drives the quadrature modulator 22 at a frequency that reflects the rate of data transfer. Preferably, the local oscillator 23 is a voltage controlled oscillator. The quadrature modulator 22 has an RF output that is connected 111 to the coaxial cable 29. More preferably, the local oscillator 23 drives the quadrature modulator 22 at a frequency of about 1 Ghz to about 1.3 Ghz.

Likewise, as described above in FIG. 4, the coaxial cable 29 transmits RF signals to the direct conversion tuner 25. The direct conversion tuner 25 converts the RF signal into analog signals TPA 97 and TPB 99 that are suitable for transmission along IEEE1394. A local oscillator 27 drives the direct conversion tuner 25 at a frequency that reflects the rate of data transfer. Preferably, the local oscillator 27 is a voltage controlled oscillator. More preferably, the local oscillator 27 drives the direct conversion tuner 25 at a frequency of about 1 Ghz to about 1.3 Ghz. Most preferably, either the local oscillator 23 is set at about 1 Ghz and the local oscillator 27 is set at about 1.3 Ghz, or the local oscillator 23 is set at about 1.3 Ghz and the local oscillator 27 is set at about 1 Ghz.

Preferably, the system includes a driver/receiver module 109 and a microprocessor 91. The driver/receiver module 109 is connected to the coaxial cable 29 and a microprocessor 91. The microprocessor 91 is connected to the arbitration logic array 89, voltage controlled oscillators 23 and 27, and the direct conversion tuner 25. As will be readily understood by one of ordinary skill in the art, the microprocessor 91 sets voltage levels of the arbitration logic array 89 such that the voltage levels are of values recognized by the system. The microprocessor 91 also sets the frequency of the local oscillators 23 and 27, and adjusts the gain in the direct conversion tuner 25 to reflect the frequency at which local oscillator 27 is set. The driver/receiver module 109 monitors signals sent and received along the coaxial cable 29.

Having thus generally described the invention, the same will become better understood from the following claims in which it is set forth in a non-limiting manner.

1. A method for transmitting signals between a high speed serial bus having at least one pair of twisted wires comprising at least a first wire and a second wire and a single conductor coaxial cable, comprising:
inputting said first wire directly into the In-phase Signal (ISIG) input of a quadrature modulator;
inputting said second wire directly into the In-phase Reference (IREF) input of a quadrature modulator having a radio frequency (RF) output;
coupling said resulting RF signal output to a coaxial cable; and
arbitrating requests from at least one device to determine which device has priority for transmitting digital signals without the use of a physical (PHY) layer.

2. The method of claim 1, further comprising,
receiving said RF signal from said coaxial cable;
converting said RF frequency signal to base band in-phase/quadrature phase signal outputs with a direct conversion tuner coupled to said coaxial cable;
coupling the resulting in-phase/quadrature phase signal outputs to said pair of twisted wires.

3. The method of claim 2, further comprising,
voltage level converting the signals from said first and second wires and level converting the in-phase/quadrature phase signal input levels.

4. The method of claim 3, wherein said high speed serial bus has a second pair of twisted wires having a third wire and a fourth wire, further comprising:
inputting said third wire directly into the Quadrature-phase Signal(QSIG) input of a quadrature modulator;
inputting said second wire directly into the Quadrature-phase Reference (QREF) input of a quadrature modulator having a radio frequency (RF) output.

5. The method of claim 4, wherein said high speed serial bus is an IEEE1394 cable.

6. A method for transporting signals between an IEEE 1394 cable having a first pair of twisted wires comprising a first and a second wire, and a second pair of twisted wires comprising a third and fourth pair of wires and a single conductor coaxial cable, comprising:
inputting the signals from the first and second wire into the In-phase Signal (ISIG) and In-phase Reference (IREF) inputs of a quadrature modulator;
inputting the signals from the third and fourth wire into the Quadrature-phase Signal (QSIG) and Quadrature-phase Reference (QREF) inputs of a quadrature modulator;
coupling the resulting quadrature modulated radio frequency signal to a coaxial cable; and
arbitrating requests from at least one device to determine which device has priority for transmitting digital signals without the use of a physical (PHY) layer.

7. The method of claim 6, further comprising
receiving said RF signal from said coaxial cable;
converting said RF frequency signal to base band in-phase/quadrature phase signal outputs with a direct conversion tuner coupled to said coaxial cable; and
coupling the resulting in-phase/quadrature phase signal outputs to said first and second pairs of twisted wires.

8. The method of claim 7, further comprising
voltage level converting signals from said first and second pair of twisted wires to in-phase/quadrature phase signal inputs.

9. An apparatus for transporting signals between a high speed serial bus and a single conductor coaxial cable, comprising:
a coaxial cable having a first end and a second end for transmission of an RF signal;
a direct quadrature modulator having analog inputs In-phase Signal (ISIG), In-phase Reference (IREF), Quadrature-phase Signal (QSIG), and Quadrature-phase Reference (QREF) inputs, and a radio frequency (RF) output coupled directly to said first end of said coaxial cable without using a physical (PHY) layer;
a first voltage controlled oscillator (VCO) set at a first frequency operatively connected to said quadrature modulator;
a high speed serial bus cable coupled to said quadrature modulator and having at least one pair of twisted wires, said pair of twisted wires having a first and second wire;
at least one of said first wire or said second wire is operatively connected to said ISIG and IREF inputs; and
a direct conversion tuner having an RF signal input coupled to said first end of said coaxial cable for converting said RF signal input into baseband ISIG, IREF, QSIG and QREF outputs;
an arbitration logic array operatively connected to said quadrature modulator and said direct conversion tuner for detecting and arbitrating signals from said ISIG, IREF, QSIG and QREF inputs and said ISIG, IREF, QSIG and QREF outputs, wherein said high speed serial bus is coupled to said quadrature modulator and said direct conversion tuner through said arbitration logic array; and
a second voltage controlled oscillator (VCO) set at a second frequency operatively connected to said direct conversion tuner.

10. The apparatus of claim 9 wherein said high speed serial bus has a second pair of twisted wires with a third and a fourth wire, wherein said first wire and said second wire is operatively connected to said ISIG and IREF inputs; and said third wire and said fourth wire is operatively connected to said QSIG and QREF inputs;

11. The apparatus of claim 10 wherein said high speed serial bus is IEEE1394.

12. The apparatus of claim 9 further comprising:
a microprocessor operatively connected to said arbitration logic, said first VCO and said second VCO for setting voltage levels.
a driver and receiver module operatively connected to said microprocessor and said coaxial cable.

13. The apparatus of claim 12 further comprising:
a second direct quadrature modulator having analog inputs In-phase Signal (ISIG), In-phase Reference (IREF), Quadrature-phase Signal (QSIG), and Quadrature-phase Reference (QREF) inputs, and a radio frequency (RF) output coupled to said second end of said coaxial cable without using a PHY layer;
a third voltage controlled oscillator (VCO) set at said second frequency operatively connected to said second quadrature modulator;
a second direct conversion tuner having a second RF signal input coupled to said second end of said coaxial cable for converting said second RF signal input into second baseband ISIG, IREF, QSIG and QREF signal outputs;
a fourth voltage controlled oscillator (VCO) set at said first frequency operatively connected to said second direct conversion tuner;
a second arbitration logic array operatively connected to said second quadrature modulator and said second direct conversion tuner for detecting and arbitrating signals from said second ISIG, IREF, QSIG and QREF inputs and said second ISIG, IREF, QSIG and QREF outputs,
a second high speed serial bus coupled to said arbitration logic array having a third pair of twisted wires with a fifth and sixth wire and a fourth pair of twisted wires with a seventh and eighth wire;
said fifth and sixth wires being operatively connected to said second ISIG and IREF inputs; and
said seventh and eighth wire being operatively connected to said second QSIG and QREF inputs.

14. The apparatus of claim 13 further comprising:
a second microprocessor operatively connected to said second arbitration logic array, said third VCO and said fourth VCO for setting voltage levels;
a second driver and receiver module operatively connected to said microprocessor and said coaxial cable.

15. An apparatus for transporting signals between an IEEE1394 cable and a single conductor coaxial cable, comprising:
a coaxial cable having a first end and a second end for transmission of an RF signal;
a direct quadrature modulator having analog inputs In-phase Signal (ISIG), In-phase Reference (IREF), Quadrature-phase Signal (QSIG), and Quadrature-phase Reference (QREF) inputs, and a radio frequency (RF) output coupled to said first end of said coaxial cable without using a PHY layer;
a first voltage controlled oscillator (VCO) set at a first frequency operatively connected to said quadrature modulator;
an IEEE1394 cable coupled to said quadrature modulator and having at a first and second pair of twisted wires, said first pair of twisted wires having a first and second wire, and said second pair of twisted wires having a third and fourth wire;
wherein said first wire is operatively connected to said ISIG and IREF inputs;
wherein said second wire is operatively connected to said QSIG and QREF inputs;
a direct conversion tuner having an RF signal input coupled to said first end of said coaxial cable for converting said RF signal input into baseband ISIG, IREF, QSIG and QREF outputs;
an arbitration logic array operatively connected to said quadrature modulator and said direct conversion tuner for detecting and arbitrating signals from said ISIG, IREF, QSIG and QREF inputs and said ISIG, IREF, QSIG and QREF outputs, wherein said high speed serial bus is coupled to said quadrature modulator and said direct conversion tuner through said arbitration logic array; and
a second voltage controlled oscillator (VCO) set at a second frequency operatively connected to said direct conversion tuner.

16. The apparatus of claim 15 further comprising:
a microprocessor operatively connected to said arbitration logic, said first VCO and said second VCO for setting voltage levels.
a driver and receiver module operatively connected to said microprocessor and said coaxial cable.

17. The apparatus of claim 16 further comprising:
a second direct quadrature modulator having analog inputs In-phase Signal (ISIG), In-phase Reference (IREF), Quadrature-phase Signal (QSIG), and Quadrature-phase Reference (QREF) inputs, and a radio frequency (RF) output coupled to said second end of said coaxial cable without using a PHY layer;
a third voltage controlled oscillator (VCO) set at said second frequency operatively connected to said second quadrature modulator;
a second direct conversion tuner having a second RF signal input coupled to said second end of said coaxial cable for converting said second RF signal input into second baseband ISIG, IREF, QSIG and QREF signal outputs;
a fourth voltage controlled oscillator (VCO) set at said first frequency operatively connected to said second direct conversion tuner;
a second arbitration logic array operatively connected to said second quadrature modulator and said second direct conversion tuner for detecting and arbitrating signals from said second ISIG, IREF, QSIG and QREF inputs and said second ISIG, IREF, QSIG and QREF outputs,
a second IEE1394 cabe coupled to said arbitration logic array having a third pair of twisted wires with a fifth and sixth wire and a fourth pair of twisted wires with a seventh and eighth wire;
said fifth and sixth wires being operatively connected to said second ISIG and IREF inputs; and
said seventh and eighth wire being operatively connected to said second QSIG and QREF inputs.

18. The apparatus of claim 17 further comprising:
a second microprocessor operatively connected to said second arbitration logic array, said third VCO and said fourth VCO for setting voltage levels;
a second driver and receiver module operatively connected to said microprocessor and said coaxial cable.
